(19) United States
(12) Patent Application Publication
(10) Pub. No.: US 2025/0060290 A1
(43) Pub. Date: Feb. 20, 2025

(54) LIVE CELL DYEING APPARATUS

(71) Applicant: ANHUI DENDRITE MEDICAL EQUIPMENT CO., LTD, Heifei, Anhui (CN)

(72) Inventors: LI-YANG CHIANG, Shanghai (CN); Liang CHEN, Shanghai (CN); Xiang ZOU, Shanghai (CN)

(21) Appl. No.: 18/723,294

(22) PCT Filed: Oct. 12, 2023
(86) PCT No.: PCT/CN2023/124185

§ 371 Date: Jun. 21, 2024

(30) Foreign Application Priority Data
Dec. 5, 2022 (CN) 202211577233.9

(51) Int. Cl. G01N 1/31; G01N 21/01; G01N 21/64

(52) U.S. Cl. CPC G01N 1/31; G01N 21/6458; G01N 2021/0112

(57) ABSTRACT

A living cell dyeing apparatus includes a dyeing chamber having multiple square holes, a sample box is arranged below each square hole, and multiple sample boxes are fixed together. A rotatable cylinder coaxial with the dyeing chamber is provided around outer wall of the dyeing chamber. Multiple physiological saline reagent bottles are inserted into the rotatable cylinder, one first dye bottle and one second dye bottle are provided in front of and at back of each physiological saline reagent bottle. Inner wall of the rotatable cylinder abuts against outer wall of the dyeing chamber to prevent liquid in the bottles from seeping out therebetween. A fluorescence microscope is arranged on the right of the dyeing chamber and is provided with a light shield. A hot air blower is in communication with right side of the light shield through an air pipe.

### CROSS REFERENCE TO RELATED APPLICATIONS

This application is a U.S. National Stage Application, filed under 35 U.S.C. 371, of International Patent Application No. PCT/CN2023/124185, filed on Oct. 12, 2023, which claims priority to Chinese Patent Application No. 202211577233.9, filed with CNIPA on Dec. 5, 2022, entitled as “LIVE CELL DYEING APPARATUS”, the entire contents of which are incorporated herein in their entireties.

### TECHNICAL FIELD

The present disclosure relates to the technical field of cell dyeing, and more particularly, relates to a live cell dyeing apparatus.

### BACKGROUND

During the fluorescence dyeing for live cell imaging analysis, when different concentrations of fluorescein sodium and methylene blue dye are used to achieve an effect of dual dyeing, processes of tissue dyeing on kidney of pig or the like include: cleaning with clean water, removing the surface membrane of the kidney, a first time of dyeing, three times of cleaning with physiological saline, a second time of dyeing, three times of cleaning with physiological saline, and so on. Existing automatic dyeing apparatuses require preparation of slides, so they are not applicable to observation on the living that can not be sliced. Fluorescent dyes need to be kept away from light, while the existing automatic dyeing apparatuses do not have the function of shading. Fluorescence phenomenon is related to the temperature, theoretically, the higher the temperature, the weaker the fluorescence intensity, so fluorescent substance at a low temperature may have significantly enhanced fluorescence intensity than under the room temperature; if porcine kidney is refrigerated in an environment of 4 degrees before the tissue dyeing, the existing automatic dyeing apparatus does not need to take into account temperatures of the tissue sample, the environment and the apparatus, then it is easy to make the objective lens fog up when observing through the microscope, which affects the observation.

If the dyeing is operated manually, a large number of manual operations affect the efficiency of tissue dyeing. The contact between human beings and tissue samples and dyes increases the chance of contamination of tissue samples and dyes, thus affecting accuracy of observation results. It is difficult to ensure the consistency of time of each operation on multiple groups of dyes with different concentrations; however, although the observation on the living needs to be completed in a short period of time, in order to avoid contamination during operating, it is necessary to carry out operations such as placing reagent bottles and cleaning the operating bench, and it is also necessary to adjust the microscope, which affects the timeliness, thereby affecting accuracy of observation results.

### SUMMARY

The present disclosure proposes a live cell dyeing apparatus, which may solve the problem of poor vital dyeing effect due to poor timeliness and easy contamination.

In view of the above, the present disclosure adopts the following technical solution.

A live cell dyeing device includes a cylindrical dyeing cavity placed in left-right direction, the dyeing chamber is provided with multiple square holes evenly distributed in left-right direction, a sample box movable in left-right direction is placed inside the dyeing chamber below each square hole, and multiple sample boxes are fixed together. An end cap is provided at a left end of the dyeing chamber. A rotatable cylinder is provided around an outer wall of the dyeing chamber, the rotatable cylinder being coaxial with the dyeing chamber. Multiple physiological saline reagent bottles are inserted into the rotatable cylinder, which are evenly distributed in left-right direction, one first dye bottle is inserted into the rotatable cylinder in front of each physiological saline reagent bottle, and one second dye bottle is inserted into the rotatable cylinder at the back of each physiological saline reagent bottle. The rotatable cylinder can rotate relative to the dyeing chamber. An inner wall of the rotatable cylinder abuts against the outer wall of the dyeing chamber to prevent liquid in the bottles from seeping out therebetween. A fluorescence microscope is provided on the right of the dyeing chamber, the fluorescence microscope is provided with a light shield which shields an objective lens of the fluorescence microscope and the dyeing chamber. A hot air blower is in communication with a right side of the light shield through an air pipe, the hot air blower blowing a thermostatic gas into the light shield.

The above technical solution is further described as follows.

Tracks symmetrical in front-back direction are provided in the dyeing chamber, right ends of the tracks are located on the right of the fluorescence microscope; each track is provided with a slide groove tilting downward toward a center, insert plates tilting upward toward two sides are respectively secured on a front end and a back end of each sample box, and the insert plates are inserted into the slide grooves on corresponding sides.

The above technical solution is further described as follows.

A drain pipe is inserted into a lower part of a left end of the end cap, and the drain pipe is in communication with the dyeing chamber.

The above technical solution is further described as follows.

The sample box is a box with an opening facing upward, and multiple through slots in front-back direction are evenly distributed from left to right in the sample box; there is a rectangle-frame-shaped pressing piece inside the sample box, and a fixing block is fixed onto each of four corners of a lower surface of the pressing piece.

The above technical solution is further described as follows.

A first hole is provided in a left surface of the end cap, a first operating lever movable in left-right direction is inserted through the first hole, and and a right end of the first operating lever is fixed onto a left surface of the sample box.

The above technical solution is further described as follows.

A second operating lever is fixed onto a left surface of the rotatable cylinder.

The above technical solution is further described as follows.

A blind hole is provided in a front part of the outer wall of the dyeing chamber, a pin is inserted into the blind hole, an outer end of the pin is hemispherical, and a spring is provided between an inner end of the pin and a bottom of the blind hole. Five depressions are provided in the inner wall of the rotatable cylinder, the five depressions are located where able to be aligned to the blind hole. As the rotatable cylinder rotates, the depressions are respectively in communication with the blind hole, and the first dye bottles, a middle position between the first dye bottles and the physiological saline reagent bottles, the physiological saline reagent bottles, a middle position between the the physiological saline reagent bottles and the second dye bottles, and the second dye bottles are successively positioned directly above the rotatable cylinder.

The above technical solution is further described as follows.

Two openings are respectively provided in a left side and an upper side of the light shield, an opening in the left side coinciding with a right side of the dyeing chamber, and an opening in the upper side being able to accommodate the objective lens of the fluorescent microscope therein.

The above technical solution is further described as follows.

A holder is fixed at each of left and right ends of the dyeing chamber, the holder including a plate placed below the dyeing chamber and two inclined plates in front-back direction each connecting the plate to the dyeing chamber.

The above technical solution is further described as follows.

The rotatable cylinder is provided with multiple second sockets, and the multiple physiological saline reagent bottles, multiple first dye bottles and multiple second dye bottles are respectively inserted into corresponding second holes.

In summary, due to the adoption of the above technical solution, the present disclosure has following beneficial effects.

(1) By operating the second operating lever to drive the rotatable cylinder to rotate, rapid dyeing and cleaning are realized; timeliness is improved and it is applicable to vital dyeing; at the same time, synchronous dyeing is performed on multiple sets of samples, which ensures consistency of time of each operation, excludes operation errors, and improves efficiency and accuracy.

(2) By operating the first operating lever to drive the multiple sample boxes containing porcine kidneys to move left and right, rapid observation of multiple sets of samples after dyeing is realized; there is no need to adjust the microscope for many times, observation on the living is completed within a short period of time, thereby improving timeliness and avoiding affecting the activity of the samples.

(3) The objective lens of the fluorescence microscope and the dyeing chamber are covered by the light shield, the hot air blower on the right of the light shield 10 blows thermostatic gas into the light shield through the air pipe, and the thermostatic gas is blown out from the opening in the upper side; hence, on the one hand, the temperature difference between the objective lens of the fluorescence microscope and the environment inside the apparatus is reduced and the objective lens of the fluorescence microscope becomes less prone to be fogged, and, on the other hand, blowing the gas to the objective lens of the fluorescent microscope can quickly eliminate the fog on the objective lens to avoid interfering with observation. The temperature is suitable, the shading effect is good, the fluorescence intensity is high, and the observation is accurate.

(4) By squeezing the four corners of the porcine kidney through the four fixing blocks of the pressing piece, on the one hand, the porcine kidney is fixed, and on the other hand, the surface of the porcine kidney is taut, which is convenient for subsequent observation.

(5) There is no contact between a person and tissue samples or dyes in the use of the present disclosure, so as to avoid contamination of the tissue samples and the dyes, etc. and adverse impact on the accuracy of observation results.

### BRIEF DESCRIPTION OF THE DRAWINGS

FIG. 1 is a schematic diagram of a stereostructure according to the present disclosure;

FIG. 2 is a schematic diagram of a stereostructure without a light shield 10 according to the present disclosure;

FIG. 3 is a main view according to the present disclosure;

FIG. 4 is a sectional view along A-A in FIG. 3;

FIG. 5 is a partial enlarged view of B in FIG. 4;

FIG. 6 is a schematic diagram of a stereostructure of a rotatable cylinder 5;

FIG. 7 is a schematic diagram of a stereostructure of a dyeing chamber 1;

FIG. 8 is a schematic diagram of a stereostructure of sample boxes 3;

FIG. 9 is a schematic diagram of a stereostructure of a pressing piece 17;

FIG. 10 is a schematic diagram of a stereostructure of the light shield 10;

FIG. 11 shows a view of cell morphology observed via a fluorescence microscope;

FIG. 12 shows a view of cell morphology observed via a fluorescence microscope; and

FIG. 13 shows a view of cell morphology observed via a fluorescence microscope.

### DETAILED DESCRIPTION OF THE EMBODIMENTS

Technical solutions in embodiments of the present disclosure are clearly and completely described below in conjunction with accompanying drawings used in the embodiments of the present disclosure. It is clear that the described embodiments are only a part of rather than all of the embodiments of the present disclosure. Based on the described embodiments in the present disclosure, all other embodiments obtained by a person of ordinary skill in the art without making creative labor fall within the scope of protection of the present disclosure.

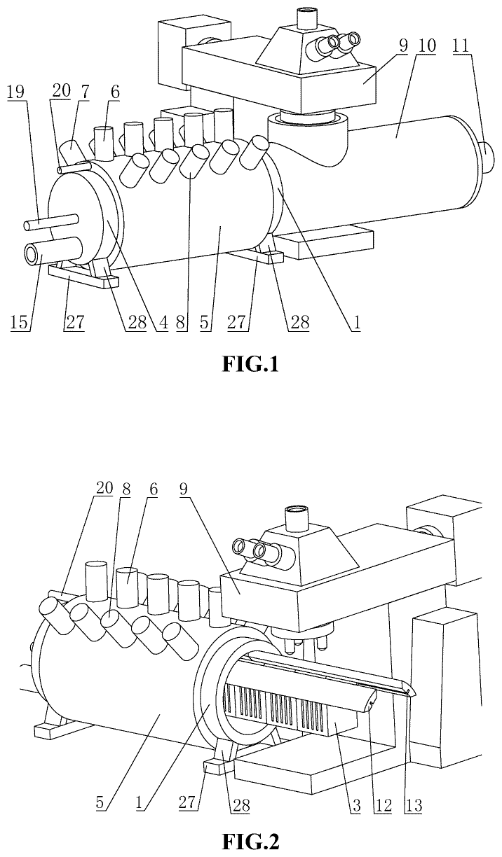

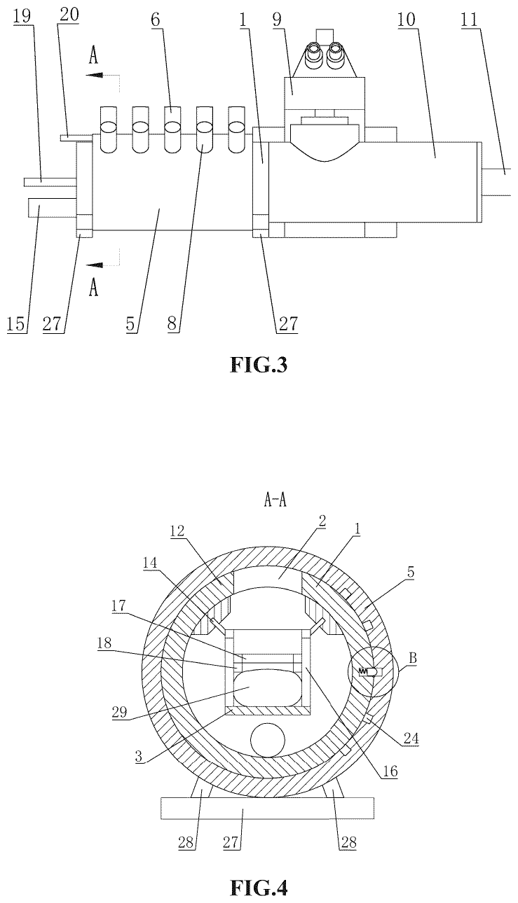

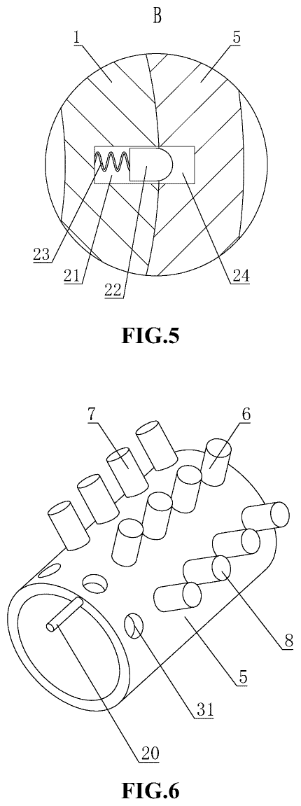

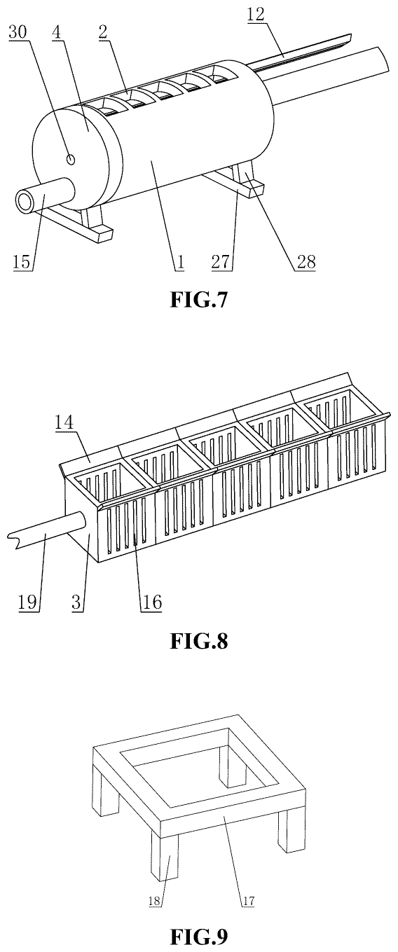

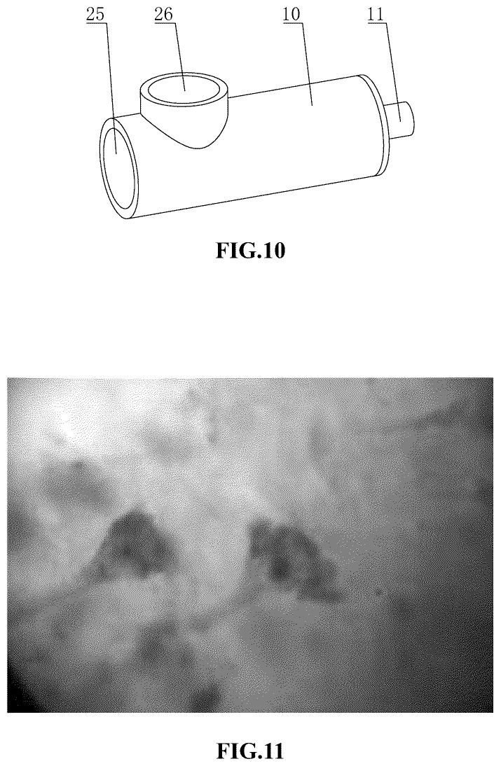

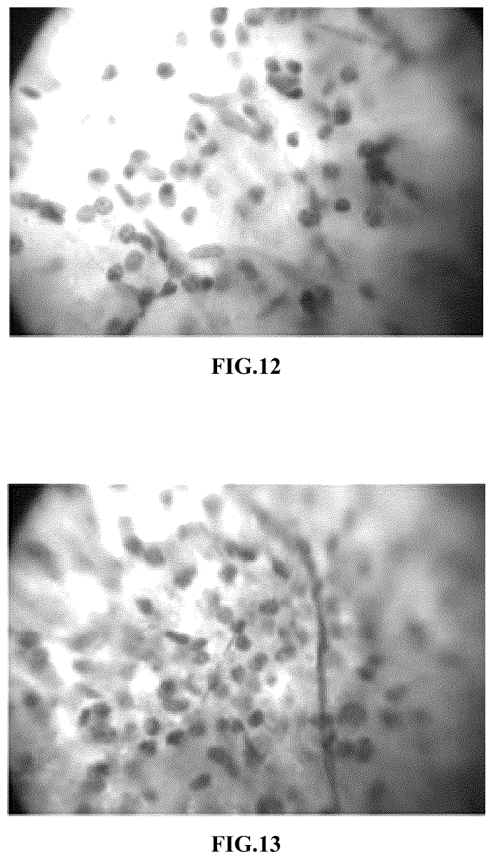

With reference to FIGS. 1-13, the present disclosure provides a technical solution for a live cell dyeing apparatus.

A live cell dyeing apparatus includes a cylindrical dyeing chamber 1 placed in left-right direction, the dyeing chamber 1 is provided with multiple square holes 2 which are evenly distributed in left-right direction, a sample box 3 movable in left-right direction is placed inside the dyeing chamber 1 below each square hole 2, and multiple sample boxes 3 are fixed together. An end cap 4 is provided at a left end of the dyeing chamber 1. A rotatable cylinder 5 is provided around an outer wall of the dyeing chamber 1, the rotatable cylinder 5 being coaxial with the dyeing chamber 1. Multiple physiological saline reagent bottles 6 are inserted into the rotatable cylinder 5, which are evenly distributed in left-right direction. One first dye bottle 7 is inserted into the rotatable cylinder 5 in front of each physiological saline reagent bottle 6, and one second dye bottle 8 is inserted into the rotatable cylinder 5 at the back of each physiological saline reagent bottle 6. The rotatable cylinder 5 can rotate relative to the dyeing chamber 1. An inner wall of the rotatable cylinder 5 abuts against the outer wall of the dyeing chamber 1, to prevent the liquid in the bottles from seeping out between the inner wall of the rotatable cylinder 5 and the outer wall of the dyeing chamber 1. A fluorescence microscope 9 is provided on the right of the dyeing chamber 1. The fluorescence microscope 9 is provided with a light shield 10 which shades an objective lens of the fluorescence microscope 9 and the dyeing chamber 1. A hot air blower is in communication with a right side of the light shield 10 through an air pipe 11, and the hot air blower blows a thermostatic gas into the light shield 10.

Tracks 12 are provided in the dyeing chamber 1, the tracks 12 being symmetrical in front-back direction. Right ends of the tracks 12 are located on the right of the fluorescence microscope 9. Each track 12 is provided with a slide groove 13 tilting downward toward a center, insert plates 14 tilting upward toward two sides are respectively secured on a front end and a back end of each sample box 3, and the insert plates 14 are inserted into the slide grooves 13 on corresponding sides.

A drain pipe 15 is inserted into a lower part of a left end of the end cap 4, and the drain pipe 15 is in communication with the dyeing chamber 1.

The sample box 3 is a box with an opening facing upward. Multiple through slots 16 in the front-back direction are evenly distributed from left to right in the sample box 3. Inside the sample box 3, there is a rectangle-frame-shaped pressing piece 17, and a fixing block 18 is fixed onto each of four corners of a lower surface of the pressing piece 17.

A first hole 30 is provided in a left surface of the end cap 4, a first operating lever 19 movable in left-right direction is inserted through the first hole 30, and a right end of the first operating lever 19 is fixed onto a left surface of the sample box 3.

A second operating lever 20 is fixed onto a left surface of the rotatable cylinder 5.

A blind hole 21 is provided in a front part of the outer wall of the dyeing chamber 1; a pin 22 is inserted into the blind hole 21; an outer end of the pin 22 is hemispherical, and a spring 23 is provided between an inner end of the pin 22 and a bottom of the blind hole 21. Five depressions 24 are provided in the inner wall of the rotatable cylinder 5; the five depressions 24 are located where able to be aligned to the blind hole 21, and as the rotatable cylinder 5 rotates, the depressions 24 can respectively be in communication with the blind hole 21; in addition, when the five depressions 24 are in communication with the blind hole 21 respectively as the rotatable cylinder 5 rotates, the first dye bottles 7, a middle position between the first dye bottles 7 and the physiological saline reagent bottles 6, the physiological saline reagent bottles 6, a middle position between the the physiological saline reagent bottles 6 and the second dye bottles 8, and the second dye bottles 8 are successively positioned directly above the rotatable cylinder 5.

Two openings are respectively provided in a left side and an upper side of the light shield 10, opening 25 in the left side coinciding with a right side of the dyeing chamber 1, and opening 26 in the upper side being able to accommodate the objective lens of the fluorescence microscope 9 therein.

A holder is fixed at each of left and right ends of the dyeing chamber 1. The holder includes a plate 27 placed below the dyeing chamber 1 and two inclined plates 28 in front-back direction each connecting the plate 27 to the dyeing chamber 1.

The rotatable cylinder 5 is provided with multiple second holes 31, where multiple physiological saline reagent bottles 6, multiple first dye bottles 7 and multiple second dye bottles 8 are respectively inserted into corresponding second holes 31.

Principle of operating is given hereinafter.

Preparations before tissue dyeing on porcine kidneys 29 using different concentrations of fluorescein sodium and methylene blue dye for effect of dual dyeing are described as follows.

1. Preparation of porcine kidneys 29. A number of fresh porcine kidneys 29 are procured and refrigerated at 4° C. for spare use. The fresh porcine kidneys 29 are washed with water, divided equally into pieces, and respectively loaded into multiple sample boxes 3. In each sample box 3, a pressing piece 17 is placed into the sample box 3, so that four corners of the porcine kidney 29 are pressed by four fixing blocks 18 to, on the one hand, fix the porcine kidney 29 and, on the other hand, make surfaces of the porcine kidney 29 to be taut, facilitating subsequent observation.

2. Preparation of reagent bottles. Fluorescein sodium of concentrations of 0.1%, 0.25%, 0.5% and 1% are loaded into multiple first dye bottles 7 from left to right, respectively; methylene blue dye of concentrations of 0.5%, 1%, 2% and 3% are loaded into multiple second dye bottles 8 from left to right, respectively; and plenty of physiological saline is injected into multiple physiological saline reagent bottles 6.

3. Apparatus adjustment. By operating the second operating lever 20 to move back and forth, the rotatable cylinder 5 is driven to rotate and the middle position between the first dye bottles 7 and the physiological saline reagent bottles 6 is placed directly above the rotatable cylinder 5, where the square holes 2 in the dyeing chamber 1 are closed by the inner wall of the rotatable cylinder 5, and the inner wall of the rotatable cylinder 5 abuts against the outer wall of the dyeing chamber 1 to prevent the liquid in the bottles from seeping out between the inner wall of the rotatable cylinder 5 and the outer wall of the dyeing chamber 1. It is to be noted that, in the above process, the outer end of the pin 22 inserted in the blind hole 21 is hemispherical, as the rotatable cylinder 5 rotates and squeezes the outer end of the pin 22 so that the pin 22 compresses the spring 23, the pin 22 may enter the blind hole 21 completely and the rotatable cylinder 5 can rotate; as the rotatable cylinder 5 rotates and causes any depression 24 to be in communication with the blind hole 21, the spring 23 pushes, at the inner end of the pin 22, the pin 22 into the depression 24 to jam the rotatable cylinder 5, then the rotatable cylinder 5 stops rotating. In addition, since five depressions 24 are provided in the inner wall of the rotatable cylinder 5 and are located where able to be aligned to the blind hole 21, as the rotatable cylinder 5 rotates, the first dye bottles 7, the middle position between the first dye bottles 7 and the physiological saline reagent bottles 6, the physiological saline reagent bottles 6, the middle position between the the physiological saline reagent bottles 6 and the second dye bottles 8, and the second dye bottles 8 can be and are successively positioned directly above the rotatable cylinder 5. The multiple physiological saline reagent bottles 6, the multiple first dye bottles 7 and the multiple second dye bottles 8 are respectively inserted into corresponding second holes 31. The multiple sample boxes 3 containing porcine kidneys 29 are placed on the right of the tracks 12, the insert plates 14 on the sample boxes 3 are inserted into the slide grooves 13 on corresponding sides, and the sample boxes 3 are moved to the left so that the first operating lever 19 is inserted through the first hole 30. Here, the light shield 10 is not connected to the apparatus.

Dyeing processes are described hereinafter.

1. The multiple sample boxes 3 containing porcine kidneys 29 are driven to move to the right in response to operation on the first operating lever 19, so that each porcine kidney 29 is placed under a microscope, and surface membrane of each porcine kidney 29 is removed using scissors and tweezers. Then, the multiple sample boxes 3 containing porcine kidneys 29 are driven to move to the left in response to operation on the first operating lever 19, so that the multiple sample boxes 3 are placed under corresponding square holes 2. Then, the opening 25 in the left side of the light shield 10 is arranged coinciding with the right side of the dyeing chamber 1, the opening 26 in the upper side of the light shield 10 can accommodate the objective lens of the fluorescence microscope 9, and the light shield 10 shades the objective lens of the fluorescence microscope 9 and the dyeing chamber 1; the hot air blower on the right of the light shield 10 blows thermostatic gas into the light shield 10 through the air pipe 11, and the thermostatic gas is blown out from the opening 26 in the upper side; hence, on the one hand, the temperature difference between the objective lens of the fluorescence microscope 9 and the environment inside the apparatus is reduced and the objective lens of the fluorescence microscope 9 becomes less prone to be fogged, and, on the other hand, blowing the gas to the objective lens of the fluorescent microscope 9 can quickly eliminate the fog on the objective lens to avoid interfering with observation.

2. The rotatable cylinder 5 is driven to rotate in response to operation on the second operating lever 20, and accordingly, the first dye bottles 7 are placed directly above the rotatable cylinder 5; the first dye bottles 7 are in communication with the dyeing chamber 1 through the second holes 31 in the rotatable cylinder 5, and the first dye bottles 7 apply different concentrations of fluorescein sodium to the porcine kidneys 29 below and surfaces of the porcine kidneys 29 are dyed for one minute. Then, the rotatable cylinder 5 is driven to rotate in response to operation on the second operating lever 20; accordingly, the physiological saline reagent bottles 6 are placed directly above the rotatable cylinder 5, and the porcine kidneys 29 are cleaned by physiological saline from the physiological saline reagent bottles 6. The rotatable cylinder 5 is driven to rotate in response to operation on the second operating lever 20, and accordingly, the middle position between the first dye bottles 7 and the physiological saline reagent bottles 6 is placed directly above the rotatable cylinder 5, the second holes 31 corresponding to the physiological saline reagent bottles 6 are closed by the outer wall of the dyeing chamber 1, the cleaning is stopped, and the dye and physiological saline in the sample boxes 3 flow downward to a lower part of the dyeing chamber 1 through the through slots 16 and are drained through the drain pipe 15.

The porcine kidneys 29 are further cleaned twice using physiological saline in the same manner as described above.

3. The rotatable cylinder 5 is driven to rotate in response to operation on the second operating lever 20, and accordingly, the second dye bottles 8 are placed directly above the rotatable cylinder 5. With reference to operating steps in the above process 2, the surfaces of the kidneys are dyed with different concentrations of methylene blue dye for one minute, and then cleaned three times with physiological saline.

4. The multiple sample boxes 3 containing porcine kidneys 29 are driven to move to the right in response to operation on the first operating lever 19; accordingly, the multiple sample boxes 3 are successively placed under the microscope 9 and observed under the microscope at a wavelength of 470 nm.

Observation results are shown in FIGS. 11, 12 and 13. The use of fluorescein sodium enables all cells and intercellular substances to emit light, so they are shown to be white; the use of methylene blue can absorb the light emitted by the fluorescein sodium, and cell nucleus is dyed by methylene blue to be opaque and it is shown to be black; and finally, the whole cell emits light, but the cell nucleus contains the dye absorbing the light, so it will show that cytoplasm is white (luminescent) and the cell nucleus is black (opaque).

It is worth noting that the above embodiments are only about an experiment with the effect of dual dyeing using different concentrations of fluorescein sodium and methylene blue dye, nevertheless, the apparatus is also applicable to fluorescence dyeing for live cell imaging analysis in other experiments. Appropriate dyes are selected according to the need. The dye that can be used in the first dye bottles 7 may include fluorescein sodium, indocyanine green, and other conventional fluorescence dyes. The dye in the second dye bottles 8 is not required to be fluorescent, however, the present method can still be utilized without influence if a qualified dye in the second dye bottles 8 has fluorescent property. The dye in the second dye bottles 8 can absorb the light emitted by the dye in the first dye bottles 7, and the dye that can be used may include hematoxylin, indigo rouge, methylene blue, and the like.

Preferred embodiments of the present disclosure are described as above, however, the scope of protection of the present disclosure is not limited thereto, and any equivalent substitutions or alterations made, by a skilled person familiar with the technical field, within the technical scope of the present disclosure based on technical scheme and inventive concept of the present disclosure shall fall within the scope of protection of the present disclosure.

1-10. (canceled)

11. A live cell dyeing apparatus, comprising a cylindrical dyeing chamber placed in left-right direction, wherein the dyeing chamber is provided with a plurality of square holes evenly distributed in left-right direction, a sample box movable in left-right direction is placed inside the dyeing chamber below each square hole, and a plurality of sample boxes are fixed together; wherein an end cap is provided at a left end of the dyeing chamber; wherein a rotatable cylinder is provided around an outer wall of the dyeing chamber, the rotatable cylinder being coaxial with the dyeing chamber, a plurality of physiological saline reagent bottles are inserted into the rotatable cylinder, which are evenly distributed in left-right direction, one first dye bottle is inserted into the rotatable cylinder in front of each physiological saline reagent bottle, and one second dye bottle is inserted into the rotatable cylinder at the back of each physiological saline reagent bottle; wherein the rotatable cylinder is capable of rotating relative to the dyeing chamber; wherein an inner wall of the rotatable cylinder abuts against the outer wall of the dyeing chamber to prevent liquid in the bottles from seeping out between the inner wall of the rotatable cylinder and the outer wall of the dyeing chamber; wherein a fluorescence microscope is provided on the right of the dyeing chamber, the fluorescence microscope is provided with a light shield which shields an objective lens of the fluorescence microscope and the dyeing chamber; wherein a hot air blower is in communication with a right side of the light shield through an air pipe, the hot air blower blowing a thermostatic gas into the light shield.

12. The live cell dyeing apparatus according to claim 11, wherein tracks symmetrical in front-back direction are provided in the dyeing chamber, right ends of the tracks are located on the right of the fluorescence microscope; each track is provided with a slide groove tilting downward toward a center, insert plates tilting upward toward two sides are respectively secured on a front end and a back end of each sample box, and the insert plates are inserted into the slide grooves on corresponding sides.

13. The live cell dyeing apparatus according to claim 11, wherein a drain pipe is inserted into a lower part of a left end of the end cap, and the drain pipe is in communication with the dyeing chamber.

14. The live cell dyeing apparatus according to claim 11, wherein the sample box is a box with an opening facing upward, and a plurality of through slots in front-back direction are evenly distributed from left to right in the sample box; wherein there is a rectangle-frame-shaped pressing piece inside the sample box, and a fixing block is fixed onto each of four corners of a lower surface of the pressing piece.

15. The live cell dyeing apparatus according to claim 11, wherein a first hole is provided in a left surface of the end cap, a first operating lever movable in left-right direction is inserted through the first hole, and a right end of the first operating lever is fixed onto a left surface of the sample box.

16. The live cell dyeing apparatus according to claim 11, wherein a second operating lever is fixed onto a left surface of the rotatable cylinder.

17. The live cell dyeing apparatus according to claim 11, wherein a blind hole is provided in a front part of the outer wall of the dyeing chamber, a pin is inserted into the blind hole, an outer end of the pin is hemispherical, and a spring is provided between an inner end of the pin and a bottom of the blind hole; wherein five depressions are provided in the inner wall of the rotatable cylinder, the five depressions are located where able to be aligned to the blind hole; and wherein as the rotatable cylinder rotates, the depressions are respectively in communication with the blind hole, and the first dye bottles, a middle position between the first dye bottles and the physiological saline reagent bottles, the physiological saline reagent bottles, a middle position between the the physiological saline reagent bottles and the second dye bottles, and the second dye bottles are successively positioned directly above the rotatable cylinder.

18. The live cell dyeing apparatus according to claim 11, wherein two openings are respectively provided in a left side and an upper side of the light shield, an opening in the left side coinciding with a right side of the dyeing chamber, and an opening in the upper side being able to accommodate the objective lens of the fluorescent microscope therein.

19. The live cell dyeing apparatus according to claim 11, wherein a holder is fixed at each of left and right ends of the dyeing chamber, the holder comprising a plate placed below the dyeing chamber and two inclined plates in front-back direction each connecting the plate to the dyeing chamber.

20. The live cell dyeing apparatus according to claim 11, wherein the rotatable cylinder is provided with a plurality of second holes, and the plurality of physiological saline reagent bottles, first dye bottles and second dye bottles are respectively inserted into corresponding second holes.
